(19) United States
(12) Patent Application Publication
(10) Pub. No.: US 2014/0289393 A1
(43) Pub. Date: Sep. 25, 2014

(54) NETWORK APPARATUS AND CONNECTION DETECTING METHOD THEREOF

(71) Applicant: REALTEK SEMICONDUCTOR CORPORATION, HSINCHU (TW)

(72) Inventors: Kuang-Yu YEN, Taichung City (TW); Yu-Chen LIU, Taipei City (TW); Tzu-Hung HSU, Zhubei City (TW)

(73) Assignee: REALTEK SEMICONDUCTOR CORPORATION, HSINCHU (TW)

(21) Appl. No.: 14/094,226

(22) Filed: Dec. 2, 2013

(30) Foreign Application Priority Data
Mar. 20, 2013 (TW) 102109775

(51) Int. Cl. H04W 48/18

(52) U.S. Cl. CPC H04W 48/18
USPC 709/224

(57) ABSTRACT

A network apparatus and a connection detecting method thereof are disclosed. The network apparatus receives a network connection request which determines a wireless network connection between a USB network controller and a wireless network access point. The network apparatus determines a network connection frequency band of the wireless network connection according to the network connection request, and switches a data transmission mode of the USB network controller from a first USB operation mode to a second USB operation mode after determining that an operation frequency of the first USB operation mode conflicts with the network connection frequency band.

This application claims priority to Taiwan Patent Application No. 102109775 filed on Mar. 20, 2013, which is hereby incorporated by reference in its entirety.

### CROSS-REFERENCES TO RELATED APPLICATIONS

Not applicable.

### BACKGROUND OF THE INVENTION

1. Field of the Invention

The present invention relates to a network apparatus and a connection detecting method thereof. More particularly, the network apparatus and the connection detecting method thereof according to the present invention can detect whether a universal serial bus (USB) operation mode and a wireless network connection interfere with each other when a USB network controller is establishing the wireless network connection.

2. Descriptions of the Related Art

As an input/output (I/O) interface specification that is currently the most widely used in various computer peripheral devices, the universal serial bus (USB) specification has the prominent features of supporting Hot-Plug and Plug-n-Play and having a high transmission speed. One of the common applications of the USB specification is the USB wireless network controller card.

With advancement of the network technologies, the data rate of the wireless local area networks (WLANs) also becomes increasingly faster and has now reached the Gbps (giga bit per second) level. In this case, for wireless network controller cards adopting the USB 2.0 specification for data transmission, a bottleneck in terms of the data rate is caused because the maximum data rate of USB. 2.0 is only 480 Mbps (mega bits per second) which is slower than the network transmission rate. In view of this, the USB 3.0 specification allowing for a maximum data rate of 5 Gbps has been introduced in some wireless network controller cards to increase the overall data rate.

However, buses of the USB 3.0 specification operate at an operation frequency of 2.5 GHz, so the radiation and signal coupling caused during physical transferring of data signals in the buses will cause serious interference to wireless networks (e.g., 802.11b/g/n) that use frequency bands around 2.4-2.6 GHz for data transmission. Consequently, it is impossible to effectively complete the overall data transmission when a user desires to use a USB wireless network controller card adopting the USB 3.0 specification to transmit data and communicate with a wireless network operating within the 2.4-2.6 frequency band at the same time.

Accordingly, an urgent need exists in the art to provide a solution capable of detecting whether a USB data transmission specification of a USB wireless network controller card interferes with a wireless network frequency band before the USB wireless network controller card establishes a connection with a wireless access point so as to improve the data transmission efficiency.

### SUMMARY OF THE INVENTION

To solve the aforesaid problem, the present invention provides a network apparatus and a connection detecting method thereof, which mainly detect whether a data transmission specification of a USB network controller in use causes signal interferences to a frequency band of a wireless network to which a user desires to connect, and perform corresponding adjustments when possible interferences are determined to occur.

The present invention provides a network apparatus, which is connected with a universal serial bus (USB) network controller. The network apparatus comprises an input/output interface and a processor. The input/output interface is configured to receive a network connection request. The network connection request determines a wireless network connection between the USB network controller and a wireless network access point. The processor is configured to determine a network connection frequency band of the wireless network connection according to the network connection request and switch a data transmission mode of the USB network controller from a first USB operation mode to a second USB operation mode after determining that an operation frequency of the first USB operation mode conflicts with the network connection frequency band.

The present invention further provides a connection detecting method for use in a network apparatus. The network apparatus is connected with a USB network controller. The connection detecting method comprises the following steps of: (a) receiving a network connection request, wherein the network connection request determines a wireless network connection between the USB network controller and a wireless network access point; (b) determining a network connection frequency band of the wireless network connection according to the network connection request; (c) determining that an operation frequency of a first USB operation mode of the USB network controller conflicts with the network connection frequency band; and (d) switching a data transmission mode of the USB network controller from the first USB operation mode to a second USB operation mode according to the result of the step (c).

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1A is a schematic view illustrating network connection relationships for a network apparatus according to a first embodiment of the present invention;

FIG. 1B is a schematic view of the network apparatus according to the first embodiment of the present invention; and

FIG. 2 is a flowchart diagram of a connection detecting method according to a second embodiment of the present invention.

### DESCRIPTION OF THE PREFERRED EMBODIMENT

In the following description, the present invention will be explained with reference to embodiments thereof. However, these embodiments are not intended to limit the present invention to any specific environment, applications or particular implementations described in these embodiments. Therefore, description of these embodiments is only for purpose of illustration but not to limit the present invention. In the following embodiments and attached drawings, elements unrelated to the present invention are omitted from depiction; and dimensional relationships among the individual elements in the attached drawings are illustrated only for ease of understanding, but not to limit the actual scale.

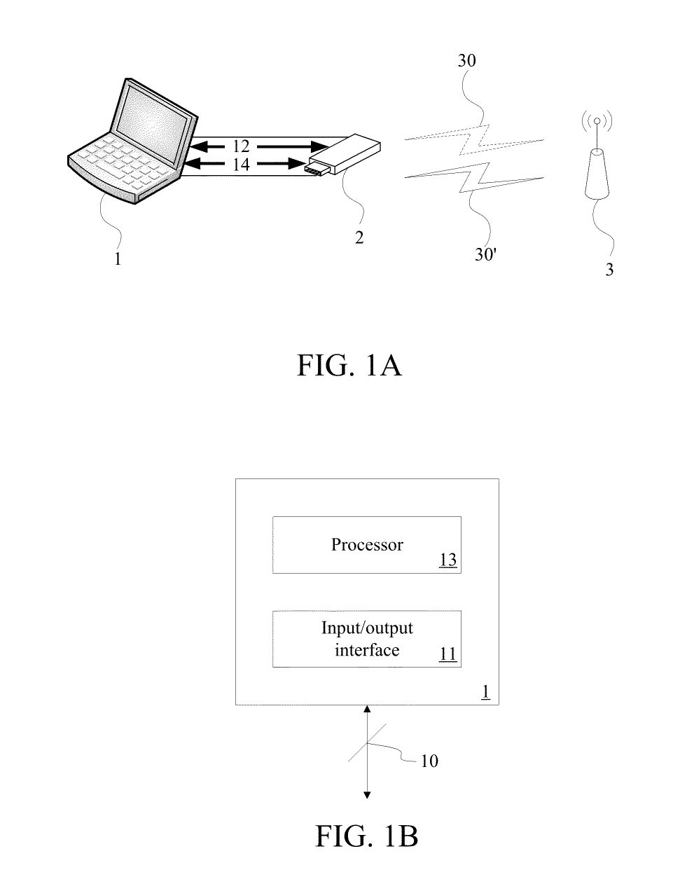

Please refer to FIGS. 1A-1B together. FIG. 1A is a schematic view illustrating network connection relationships for a network apparatus 1 according to a first embodiment of the present invention. The network apparatus 1 is connected with a universal serial bus (USB) network controller 2. FIG. 1B is a schematic view of the network apparatus 1 according to the first embodiment of the present invention. The network apparatus 1 comprises an input/output (I/O) interface 11 and a processor 13.

It should be appreciated that, in the present invention, the network apparatus 1 may be a computing apparatus (e.g., a desk-top computer, a notebook computer or a handheld mobile apparatus) that needs to establish a network connection via a USB network controller, the I/O interface 11 may be a human-machine interface (HMI) with I/O functions (e.g., a mouse or a keyboard), and the processor 13 may be a processor unit with micro-processing and computing functions. This can be readily appreciated by those skilled in the art, so no further description will be made herein. Interactions between individual elements will be further described hereinafter.

Firstly, when a user who is using the network apparatus 1 desires to connect with a wireless network access point 3 via a USB network controller 2, the user can input a network connection request 10 via the I/O interface 11 of the network apparatus 1. In other words, the I/O interface 11 of the network apparatus 1 receives the network connection request 10 from the user. The user can determine in the network connection request 10 the type of a wireless network connection 30 between the USB network controller 2 and the wireless network access point 3 according to a network service provided by the wireless network access point 3.

The network connection request 10 comprises settings related to the wireless network connection 30 which the user desires to establish. Therefore, after the network connection request 10 is received by the I/O interface 11 of the network apparatus 1, the processor 13 of the network apparatus 1 can determine a network connection frequency band (not shown) of the wireless network connection 30 which the user selects to establish according to the network connection request 10, and further determine whether an operation frequency of a first USB operation mode 12 which the USB network controller 2 currently uses falls within or around the network connection frequency band of the wireless network connection 30 (i.e., determine whether the operation frequency of the first USB operation mode 12 of the USB network controller 2 conflicts with the network connection frequency band).

If the operation frequency of the first USB operation mode 12 falls within or around the network connection frequency band of the wireless network connection 30, then the operation frequency for data transmission of the USB network controller 2 and the network connection frequency band of the wireless network connection 30 will interfere with each other after the wireless network connection 30 is established. In view of this, the processor 13 switches a data transmission mode of the USB network controller 2 from the first USB operation mode 12 to a second USB operation mode 14 firstly so that the operation frequency of the second USB operation mode 12 falls outside the network connection frequency band of the wireless network connection 30. For example, the data transmission mode is switched from a USB 3.0 operation mode to a USB 2.0 operation mode.

Thus, the operation frequency for data transmission of the USB network controller 2 and the network connection frequency band of the wireless network connection 30 will not interfere with each other after the wireless network connection 30 is established. Accordingly, the processor 13 can actually establish a wireless network connection 30′ between the USB network controller 2 and the wireless network access point after the data transmission mode of the USB network controller 2 is switched from the first USB operation mode 12 to the second USB operation mode 14 (i.e., after the possible interferences are avoided).

On the other hand, if the operation frequency of the first USB operation mode 12 does not fall within the network connection frequency band of the wireless network connection 30, the operation frequency for data transmission of the USB network controller 2 and the network connection frequency band of the wireless network connection 30 will not interfere with each other after the wireless network connection 30 is established. Accordingly, the processor 13 directly establishes the wireless network connection 30′ between the USB network controller 2 and the wireless network access point without switching the data transmission mode.

For example, if there is another wireless network access point that provides a different type of connection (e.g., 802.11a/b/g/n/ac) at the same time, then the user can notify, via the network connection request, the network apparatus of the wireless network connection which he/she desires to use. In this case, if the processor of the network apparatus determines that the transmission protocol of the network connection which the user desires to establish is 802.11 b/g/n according to the network connection request, the processor of the network apparatus may further determine that the network connection frequency band of the network connection is within 2.4-2.5 GHz.

Subsequently, when the network apparatus and the USB wireless network controller transmit data in the USB 3.0 transmission mode, the processor of the network apparatus can determine that the operation frequency (2.4 GHz) of the USB 3.0 transmission mode falls within or around the network connection frequency band (2.4-2.5 GHz). In this case, the processor of the network apparatus switches the data transmission mode from the USB 3.0 transmission mode to the USB 2.0 transmission mode so that the operation frequency of the data transmission mode falls outside the network connection frequency band. In this way, signal interferences possibly occurring after the connection is established can be avoided.

On the other hand, if the processor of the network apparatus determines that the transmission protocol of the network connection which the user desires to establish is 802.11 a/ac according to the network connection request, the processor of the network apparatus can further determine that the network connection frequency band of the network connection is 5-5.785 GHz. In this case, even if the transmission mode adopted between the network apparatus and the USB network controller is the USB 3.0 transmission mode, the processor of the network apparatus can still directly establish the network connection without switching the data transmission mode because the operation frequency (2.4 GHz) of the data transmission mode does not fall within or around the network connection frequency band.

It should be appreciated that, when the wireless network connection disconnects or the user desires to re-establish a connection, the network apparatus of the present invention can repeat the aforesaid operations to receive a network connection request again from the user, determine whether the operation frequency of the USB operation mode falls within the network connection frequency band according to the network connection request, and perform corresponding adjustments correspondingly.

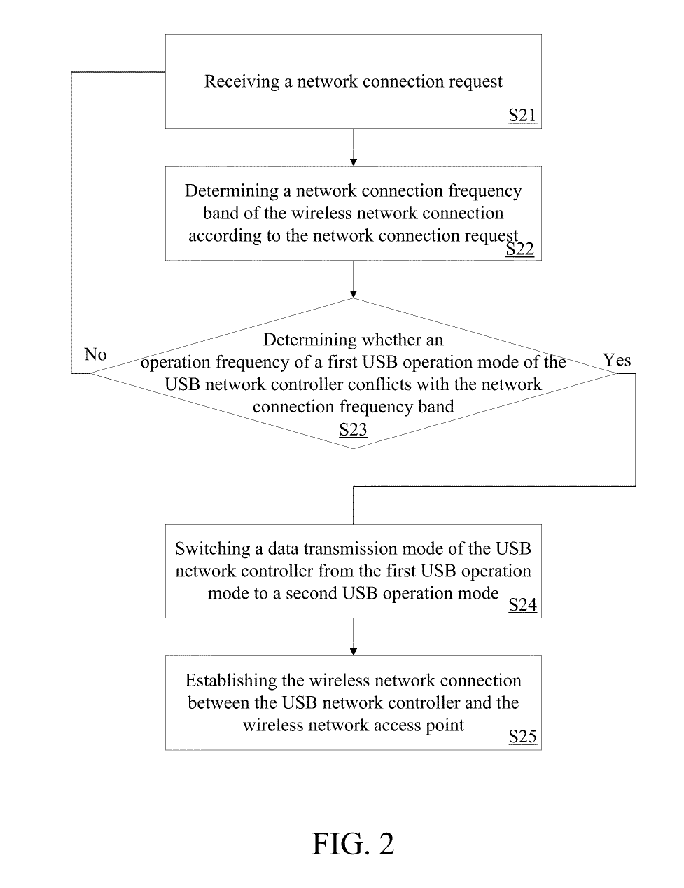

Referring to FIG. 2, it illustrates a USB network controller connection detecting method according to a second embodiment of the present invention. The method of the second embodiment is for use in a network apparatus (e.g., the network apparatus 1 of the aforesaid embodiment), which is connected with a USB network controller. The flowchart diagram of the connection detecting method is shown in FIG. 2.

Firstly, step S21 is executed to enable the network apparatus to receive a network connection request from a user. The network connection request determines a wireless network connection between the USB network controller and a wireless network access point. Subsequently, step S22 is executed to enable the network apparatus to determine a network connection frequency band of the wireless network connection according to the network connection request. Then, step S23 is executed to enable the network apparatus to determine whether an operation frequency of a first USB operation mode of the USB network controller falls within or around the network connection frequency band (i.e., determine whether the operation frequency of the first USB operation mode of the USB network controller conflicts with the network connection frequency band).

Subsequently, if the operation frequency of the first USB operation mode of the USB network controller conflicts with the network connection frequency band, step S24 is executed to enable the network apparatus to switch a data transmission mode of the USB network controller from the first USB operation mode to a second USB operation mode. For example, the data transmission mode is switched from the USB 3.0 operation mode to the USB 2.0 operation mode. The operation frequency of the second USB operation mode falls outside the network connection frequency band. Finally, step S25 is executed to enable the network apparatus to establish the wireless network connection between the USB network controller and the wireless network access point. Otherwise, if the operation frequency of the first USB operation mode of the USB network controller does not conflict with the network connection frequency band, the method is repeated back from step S21.

According to the above descriptions, the present invention provides a network apparatus and a USB network controller connection detecting method for use in a network apparatus. The network apparatus and the connection detecting method mainly determine a network connection frequency band of a wireless network connection, which a user desires to establish, according to a network connection request from the user and further determine whether the wireless network connection interferes with the operation frequency of the data transmission mode of the USB network controller. If the answer is yes, then the data transmission mode of the USB network controller is switched firstly before the network connection is established. Otherwise, if the answer is no, then the network connection is directly established without switching the data transmission mode of the USB network controller. In this way, possible interferences between the data transmission mode of the USB network controller and the wireless network frequency band can be avoided.

The above disclosure is related to the detailed technical contents and inventive features thereof People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A connection detecting method for use in a network apparatus, the network apparatus is connected with a universal serial bus (USB) network controller, the connection detecting method comprising the following steps of:
(a) receiving a network connection request, wherein the network connection request determines a wireless network connection between the USB network controller and a wireless network access point;
(b) determining a network connection frequency band of the wireless network connection according to the network connection request;
(c) determining whether an operation frequency of a first USB operation mode of the USB network controller conflicts with the network connection frequency band; and
(d) switching a data transmission mode of the USB network controller from the first USB operation mode to a second USB operation mode if the operation frequency of the first USB operation mode of the USB network controller conflicts with the network connection frequency band.

2. The connection detecting method as claimed in claim 1, wherein the operation frequency of the second USB operation mode falls outside the network connection frequency band.

3. The connection detecting method as claimed in claim 1, further comprising the following step of:
(e) establishing the wireless network connection between the USB network controller and the wireless network access point.

4. The connection detecting method as claimed in claim 1, wherein the network connection frequency band is within 2.4-2.5 GHz, the first USB operation mode is a USB 3.0 transmission mode, and the second USB operation mode is a USB 2.0 transmission mode.

5. A network apparatus, connecting to a universal serial bus (USB) network controller, comprising:
a input/output interface, being configured to receive a network connection request, wherein the network connection request is related to a wireless network connection between the USB network controller and a wireless network access point; and
a processor, being configured to determine a network connection frequency band of the wireless network connection according to the network connection request and switch a data transmission mode of the USB network controller from a first USB operation mode to a second USB operation mode after determining that an operation frequency of the first USB operation mode conflicts with the network connection frequency band.

6. The network apparatus as claimed in claim 5, wherein the operation frequency of the second USB operation mode falls outside the network connection frequency band.

7. The network apparatus as claimed in claim 5, wherein the processor is further configured to establish the wireless network connection between the USB network controller and the wireless network access point after switching the data transmission mode of the USB network controller from the first USB operation mode to the second USB operation mode.

8. The network apparatus as claimed in claim 5, wherein the network connection frequency band is within 2.4-2.5 GHz, the first USB operation mode is a USB 3.0 transmission mode, and the second USB operation mode is a USB 2.0 transmission mode.
